(19) United States
(12) Patent Application Publication
(10) Pub. No.: US 2023/0311696 A1
(43) Pub. Date: Oct. 5, 2023

(54) METHOD FOR CONTROLLING CHARGING AND HEATING OF POWER BATTERY, MEDIUM, DEVICE AND VEHICLE

(71) Applicant: Xiaobin Li, Beijing (CN)

(72) Inventor: Xiaobin Li, Beijing (CN)

(21) Appl. No.: 18/330,108

(22) Filed: Jun. 6, 2023

Related U.S. Application Data
(63) Continuation of application No. PCT/CN2021/136154, filed on Dec. 7, 2021.

(30) Foreign Application Priority Data
Dec. 7, 2020 (CN) 202011439395.7

(51) Int. Cl. H01M 10/615; B60L 53/62; B60L 58/27; H01M 10/657; B60L 58/12; H01M 10/633; H01M 10/625

(52) U.S. Cl. CPC B60L 53/62; B60L 58/12; B60L 58/27; H01M 10/615; H01M 10/625; H01M 10/633; H01M 10/657; B60L 2240/545

(57) ABSTRACT

The present disclosure relates to a method and apparatus for controlling charging and heating of a power battery, a medium, a device and a vehicle. The method includes: determining whether activation of a heater to heat the power battery enables a charging rate of the power battery to be accelerated during charging of the power battery; controlling the heater to be activated to heat the power battery, in response to determining that activation of the heater to heat the power battery enables the charging rate of the power battery to be accelerated; and adjusting an operating parameter of the heater to accelerate the charging rate of the power battery.

### CROSS-REFERENCE TO RELATED APPLICATION

This application is a continuation application of International Application No. PCT/CN2021/136154, filed Dec. 7, 2021, which claims priority to and benefits of Chinese Pat. Application No. 202011439395.7, filed on Dec. 07, 2020, the entire content of which is incorporated herein by reference.

### FIELD

The present disclosure relates to the field of vehicle automatic control, and more particularly to a method and apparatus for controlling charging and heating of a power battery, a medium, a device and a vehicle.

### BACKGROUND

When a power battery of existing new energy vehicles (including plug-in hybrid vehicles, extended-range electric vehicles, and battery electric vehicles) is used in high temperature or low temperature environments, a certain thermal management measure needs to be taken to keep the power battery within a suitable temperature range. For example, a suitable temperature range for most of lithium-nickel-cobalt-manganate batteries, also called ternary batteries, is from 20 to 35° C.

In the related art, most of the power batteries adopt a simple thermal management control based on a temperature threshold. For example, under a condition of charging and heating a power battery, when the temperature of the power battery is less than or equal to 15° C., the heater is turned on; when the temperature of the power battery is greater than 18° C., the heater is turned off. In this example, the temperature range of 15 to 18° C. is a temperature hysteresis interval, and 15° C. and 18° C. are two temperature thresholds. At present, for heating the power battery, a high-voltage PTC (abbreviation of positive temperature coefficient) heater is usually used to heat a coolant liquid, and the coolant liquid heats the battery through a liquid cooling circuit.

### SUMMARY

Embodiments of the present disclosure provide a method for controlling charging and heating of a power battery, including:
determining whether activation of a heater to heat the power battery enables a charging rate of the power battery to be accelerated during charging of the power battery;
controlling the heater to be activated to heat the power battery, in response to determining that activation of the heater to heat the power battery enables the charging rate of the power battery to be accelerated; and
adjusting an operating parameter of the heater to accelerate the charging rate of the power battery.

Embodiments of the present disclosure also provide a computer-readable storage medium having stored therein a computer program that, when executed by a processor, causes steps of the method provided above to be realized.

Embodiments of the present disclosure also provide an electronic device, including:
a memory, having stored therein a computer program; and
a processor, configured to execute the computer program stored in the memory to realize steps of the method provided above.

Embodiments of the present disclosure also provide a vehicle, including: a power battery; and a processor. The processor is configured to execute steps of the method provided above.

Additional aspects and advantages of embodiments of present disclosure will be described in detail with reference to the following embodiments.

### BRIEF DESCRIPTION OF THE DRAWINGS

The accompanying drawings, which constitute a part of this specification, are provided for better understanding of the present disclosure, and serve to explain the present disclosure together with the following embodiments, which shall not be construed to limit the present disclosure.

FIG. 1 is a flow chart of a method for controlling charging and heating of a power battery according to an example of the present disclosure;

FIG. 2 is a flow chart of a method for controlling charging and heating of a power battery according to another example of the present disclosure;

FIG. 3 is a block diagram of an apparatus for controlling charging and heating of a power battery according to an example of the present disclosure; and

FIG. 4 is a block diagram of an electronic device according to an example of the present disclosure.

### DETAILED DESCRIPTION

Embodiments of the present disclosure will be described in detail below with reference to the accompanying drawings. It should be understood that the embodiments described herein are merely intended to illustrate and explain the present disclosure, but shall not be construed to limit the present disclosure.

During charging and heating a power battery of a vehicle, a charging device is used as an energy provider for the whole vehicle, and the power battery, a high-voltage PTC heater and other high-voltage components on the vehicle are energy consumers. The charging device may be a direct-current charging pile or an on-board charger. The direct-current charging pile is able to use a direct current to charge the power battery, and the on-board charger is able to use an alternating current to charge the power battery. During charging and heating of the power battery, when the high-voltage PTC heater is activated to heat the power battery, limited by a rated power of the charging device, the thermal management control strategy based on the above-described temperature hysteresis interval cannot guarantee the acceleration of a charging rate of the power battery, instead, sometimes the charging time of the power battery will be prolonged due to the activation of the heater, because both the heater and the power battery consume the electric energy output by the charging device. If not controlled, the PTC heater may operate with its demand current and occupy the electric energy that could have been supplied to the power battery, so it is possible that the charging time may be prolonged due to activation of the heater to heat the power battery. In view of this, the inventors of the present disclosure came up with that the heater may be controlled to be activated when it is determined that activation of the heater to heat the power battery is able to speed up the charging rate of the power battery, otherwise, the heater is not activated. Further, during the charging and heating of the power battery, an operating parameter of the heater is adjusted to accelerate the charging rate of the power battery.

Embodiments of the present disclosure are to provide a method and apparatus for controlling charging and heating of a power battery, a medium, a device and a vehicle, which are capable of accelerating a charging rate of a charging rate.

Embodiments of the present disclosure provide a method for controlling charging and heating of a power battery, including:
determining whether activation of a heater to heat the power battery enables a charging rate of the power battery to be accelerated during charging of the power battery;
controlling the heater to be activated to heat the power battery, in response to determining that activation of the heater to heat the power battery enables the charging rate of the power battery to be accelerated; and
adjusting an operating parameter of the heater to accelerate the charging rate of the power battery.

In some embodiments, the determining whether activation of the heater to heat the power battery enables the charging rate of the power battery to be accelerated during charging of the power battery includes:
determining that activation of the heater to heat the power battery enables the charging rate of the power battery to be accelerated, in response to determining that a temperature of the power battery is less than a preset temperature lower limit, and a maximum output current of a charging device is greater than a maximum permissible charging current of the power battery;
determining that activation of the heater to heat the power battery does not enable the charging rate of the power battery to be accelerated, in response to determining that the maximum output current of the charging device is less than or equal to the maximum permissible charging current of the power battery or a temperature of a battery cell of the power battery having a minimum temperature is greater than a preset temperature upper limit.

In some embodiments, the adjusting the operating parameter of the heater includes:
adjusting a current of the heater to be a difference between the maximum output current of the charging device and the maximum permissible charging current of the power battery, in response to determining that the temperature of the power battery is less than a preset approximate temperature value;
controlling the current of the heater to be reduced, in response to determining that the temperature of the power battery reaches the preset approximate temperature value; and
controlling the heater to stop operation, in response to determining that the temperature of the power battery reaches a preset temperature upper limit,
the preset approximate temperature value is less than the preset temperature lower limit.

In some embodiments, the controlling the current of the heater to be reduced in response to determining that the temperature of the power battery reaches the preset approximate temperature value includes: controlling the current of the heater to be reduced with increase in the temperature of the power battery, in response to determining that the temperature of the power battery reaches the preset approximate temperature value.

In some embodiments, the adjusting the operating parameter of the heater to accelerate the charging rate of the power battery includes: adjusting a current of the heater to make a sum of a maximum permissible charging current of the power battery and the current of the heater equal to or less than a maximum output current of the charging device to accelerate the charging rate of the power battery, in response to determining that the maximum output current of the charging device is greater than the maximum permissible charging current of the power battery, but less than a sum of the maximum permissible charging current of the power battery and a current required by the heater.

In some embodiments, the method includes: determining the current required by the heater according to the temperature of the power battery.

In some embodiments, the determining the current required by the heater according to the temperature of the power battery includes: determining the current required by the heater to be a current corresponding to a temperature interval where the temperature of the power battery falls.

In some embodiments, the adjusting the current of the heater includes:
monitoring the temperature and a state-of-charge of the power battery;
determining the maximum permissible charging current of the power battery according to the temperature and the state-of-charge of the power battery; and
adjusting the current of the heater to make the maximum output current of the charging device greater than or equal to the sum of the maximum permissible charging current of the power battery and the current of the heater.

In some embodiments, the method further includes: controlling the heater to stop operation, in response to determining that a temperature difference between a battery cell having a maximum temperature and a battery cell having a minimum temperature is greater than a preset temperature value.

Embodiments of the present disclosure also provide an apparatus for controlling charging and heating of a power battery, including:
a judging module, configured to determine whether activation of a heater to heat the power battery enables a charging rate of the power battery to be accelerated during charging of the power battery;
a first controlling module, configured to control the heater to be activated to heat the power battery, in response to determining that activation of the heater to heat the power battery enables the charging rate of the power battery to be accelerated; and
an adjusting module, configured to adjust an operating parameter of the heater to accelerate the charging rate of the power battery.

In some embodiments, the judging module includes a first judging sub-module configured to:
determine that activation of the heater to heat the power battery enables the charging rate of the power battery to be accelerated, in response to determining that a temperature of the power battery is less than a preset temperature lower limit, and a maximum output current of a charging device is greater than a maximum permissible charging current of the power battery, and
determine that activation of the heater to heat the power battery does not enable the charging rate of the power battery to be accelerated, in response to determining that the maximum output current of the charging device is less than or equal to the maximum permissible charging current of the power battery or a temperature of a battery cell of the power battery having a minimum temperature is greater than a preset temperature upper limit.

In some embodiments, the adjusting module includes:
a first adjusting sub-module, configured to adjust a current of the heater to be a difference between the maximum output current of the charging device and the maximum permissible charging current of the power battery, in response to determining that the temperature of the power battery is less than a preset approximate temperature value;
a second adjusting sub-module, configured to control the current of the heater to be reduced, in response to determining that the temperature of the power battery reaches the preset approximate temperature value; and
a third adjusting sub-module, configured to control the heater to stop operation, in response to determining that the temperature of the power battery reaches a preset temperature upper limit,
the preset approximate temperature value is less than the preset temperature lower limit.

Embodiments of the present disclosure also provide a computer-readable storage medium having stored therein a computer program that, when executed by a processor, causes steps of the method provided above to be realized.

Embodiments of the present disclosure also provide an electronic device, including:
a memory, having stored therein a computer program; and
a processor, configured to execute the computer program stored in the memory to realize steps of the method provided above.

Embodiments of the present disclosure also provide a vehicle, including: a power battery; and a processor. The processor is configured to execute steps of the method provided above.

When a power batter is charged by a charging device, if the power battery is heated by a heater at the same time, the charging device needs to supply a certain power to the heater. Through the above technical solutions, during charging of the power battery, if it is determined that activation of the heater to heat the power battery is able to speed up the charging rate of the power battery, the heater is controlled to be activated to heat the power batter, and the operating parameter of the heater is adjusted to accelerate the charging rate of the power battery and shorten charging time. The method for controlling charging and heating of a power battery according to the present disclosure avoids the occurrence of a case where the charging rate of the power battery is lowered due to heating the power battery, thereby achieving a balance between the charging time and the energy consumption for heating the power battery.

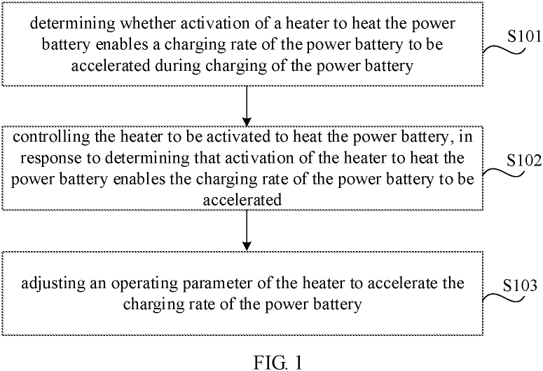

FIG. 1 is a flow chart of a method for controlling charging and heating of a power battery according to an example of the present disclosure. As illustrated in FIG. 1, the method includes the following steps.

At step S101, it is determined whether activation of a heater to heat the power battery enables a charging rate of the power battery to be accelerated during charging of the power battery.

At step S102, the heater is controlled to be activated to heat the power battery, in response to determining that activation of the heater to heat the power battery enables the charging rate of the power battery to be accelerated.

At step S103, an operating parameter of the heater is adjusted to accelerate the charging rate of the power battery.

The power battery will be charged when a charging gun is inserted into a charging port of the vehicle. During the charging of the power battery, if a temperature of the power battery is lower, the charging rate of the power battery may be affected. In view of this, the power battery may be heated at the same time, and the intention is to speed up the charging rate of the power battery. However, sometimes when the heater is activated, the charging rate of the power battery is reduced instead, because the heater also consumes a part of the electric energy output by the charging device. In embodiments of the present disclosure, before the activation of the heater, it is determined whether activation of the heater is able to speed up the charging rate of the power battery, and if it is determined that activation of the heater is able to speed up the charging rate of the power battery, the heater is activated to hearing the power battery.

Whether activation of the heater is able to speed up the charging rate of the power battery may be determined by comprehensively considering relevant parameters of the charging device, the power battery and heater, such as a maximum output current of the charging device, a maximum permissible charging current of the power battery and so on.

During heating and charging the power battery at the same time, parameters like the temperature and a state-of-charge of the power battery change in real time, if the operating parameter of the heater remains unchanged, it cannot be guaranteed that the charging rate of the power batter is accelerated in real time during the whole process of heating. Therefore, during heating and charging the power battery, the operating parameter of the heater may be adjusted according to actual situations to ensure that the charging rate of the power battery can be accelerated.

Through the above technical solutions, during charging of the power battery, if it is determined that activation of the heater to heat the power battery is able to speed up the charging rate of the power battery, the heater is controlled to be activated to heat the power batter, and the operating parameter of the heater is adjusted to accelerate the charging rate of the power battery and shorten charging time. The method for controlling charging and heating of a power battery according to the present disclosure avoids the occurrence of a case where the charging rate of the power battery is lowered due to heating the power battery, thereby achieving a balance between the charging time and the energy consumption for heating the power battery.

In another example, on the basis of FIG. 1, the step S101 of determining whether activation of the heater to heat the power battery enables the charging rate of the power battery to be accelerated includes: determining that activation of the heater to heat the power battery enables the charging rate of the power battery to be accelerated, in response to determining that a temperature of the power battery is less than a preset temperature lower limit, and a maximum output current of a charging device is greater than a maximum permissible charging current of the power battery; and determining that activation of the heater to heat the power battery does not enable the charging rate of the power battery to be accelerated, in response to determining that the maximum output current of the charging device is less than or equal to the maximum permissible charging current of the power battery or a temperature of a battery cell of the power battery having a minimum temperature is greater than a preset temperature upper limit.

During charging, the charging device (for example, the direct-current charging pile) charges the power battery with the maximum output current by default. The maximum permissible charging current of the power battery is related to the temperature of the power battery, and a battery management system is able to calculate the maximum permissible charging current of the power battery according to the temperature of the power battery in real time. For example, a correspondence between the maximum permissible charging current and the temperature of the power battery may be stored in advance, and a respective maximum permissible charging current of the power battery corresponding to a real-time temperature of the power battery may be determined by searching in the correspondence.

If the temperature of the power battery is less than the preset temperature lower limit, it is considered that the temperature of the power battery is lower, and the power battery needs to be heated. If the maximum output current of the charging device is greater than the maximum permissible charging current of the power battery, it is considered that the electric energy output by the charging device has a margin after being supplied to the power battery. In this case, if the margin is supplied to the heater, the electric energy supplied to the power battery will not be affected, and heating the power battery will accelerate the charging rate to a certain extent.

If the maximum output current of the charging device is equal to the maximum permissible charging current of the power battery, it is considered that the electric energy output by the charging device just enables the power battery to be charged at the maximum permissible charging current, without any margin; and if the maximum output current of the charging device is less than the maximum permissible charging current of the power battery, it is considered that the electric energy output by the charging device is insufficient to ensure the power battery to be charged at the maximum permissible charging current. In both cases, it is determined that the activation of the heater does not enable the charging rate of the power battery to be accelerated, no matter what the temperature of the power battery is, then the heater will not be activated, so as to avoid the heater to occupy a part of the current output by the charging device to slow down the charging rate of the power battery.

In these examples, whether to heat the power battery may be concluded directly by comparing the maximum output current of the charging device with the maximum permissible charging current of the power battery. The method is simple and the data processing speed is fast.

In an example, if the temperature of the battery cell of the power battery having the minimum temperature is greater than the preset temperature upper limit, it is considered that the temperature of the power battery is higher, the activation of the heater will make the power battery overheated, which may slow down the charging rate of the power battery or cause other faults. Therefore, if the temperature of the battery cell of the power battery having the minimum temperature is greater than the preset temperature upper limit, it is determined that activation of the heater to heat the power battery does not enable the charging rate of the power battery to be accelerated, and the heater will not be activated.

In another example, the adjusting the operating parameter of the heater in step S103 may include:
adjusting a current of the heater to be a difference between the maximum output current of the charging device and the maximum permissible charging current of the power battery, in response to determining that the temperature of the power battery is less than a preset approximate temperature value;
controlling the current of the heater to be reduced, in response to determining that the temperature of the power battery reaches the preset approximate temperature value; and
controlling the heater to stop operation, in response to determining that the temperature of the power battery reaches a preset temperature upper limit,
the preset approximate temperature value is less than the preset temperature lower limit.

When the temperature of the power battery is less than the preset temperature lower limit, it is considered that the power battery needs to be heated. When the temperature of the power battery reaches the temperature upper limit, it is considered that the power battery does not need to be heated any more. The preset approximate temperature value is slightly less than the temperature lower limit. When the temperature of the power battery reaches the approximate temperature value, it is considered that the temperature of the power battery is about to reach the preset temperature upper limit, and the hating is about to stop, and in this situation, only a small current is required by the heater to heat the temperature of the power battery to the temperature upper limit, thereby avoiding the heater to continue heating the power battery with a larger current to result in the overheating of the power battery and the consumption of unnecessary power.

For example, the preset temperature upper limit is 18° C., the preset temperature lower limit is 15° C., and the preset approximate temperature value is 12° C. At the beginning of charging, the temperature of the power battery is 5° C., and the current of the heater is the difference between the maximum output current of the charging device and the maximum permissible charging current of the power battery. When the temperature of the power battery rises to 12° C., the current of the heater is controlled to decrease, and the heating is stopped when the temperature of the power battery reaches 18° C. The reduced current value of the heater may be a preset current value.

In this example, in a stage where the temperature of the power battery is relatively lower (less than the preset approximate temperature value), all the margin of the output current of the charging equipment other than the maximum permissible charging current of the power battery is supplied to the heater, which greatly speeds up the charging rate. With the progress of heating and charging, the temperature of the power battery continues to rise, and in a stage where the charging is about to end (i.e., the temperature of the power battery is greater than preset approximate temperature value but less than the preset temperature upper limit), the current value of the heater is reduced, which not only saves electric energy, but also avoids the slowdown of charging rate and the occurrence of other faults caused by overheating of the power battery.

In another example, the controlling the current of the heater to be reduced in response to determining that the temperature of the power battery reaches the preset approximate temperature value includes: controlling the current of the heater to be reduced with increase in the temperature of the power battery, in response to determining that the temperature of the power battery reaches the preset approximate temperature value.

After the temperature of the power battery reaches the approximate temperature value, with the temperature of the power battery increases, the demand for the heater decreases. Therefore, the current of the heater may be adjusted to decrease with the increase of the temperature of the power battery, so as to avoid overheating of the power battery and save energy.

In yet another example, the step of adjusting the operating parameter of the heater to accelerate the charging rate of the power battery (step S103) may include: adjusting a current of the heater to make a sum of a maximum permissible charging current of the power battery and the current of the heater equal to or less than a maximum output current of the charging device to accelerate the charging rate of the power battery, in response to determining that the maximum output current of the charging device is greater than the maximum permissible charging current of the power battery, but less than a sum of the maximum permissible charging current of the power battery and a current required by the heater.

The current required by the heater is determined according to the temperature of the power battery. The temperature of the power battery and the current required by the heater have a predetermined correspondence, and the predetermined correspondence may be stored in advance. When the temperature of the power battery is detected, the corresponding current required by the heater may be searched in the predetermined correspondence. The correspondence may be obtained by experiments or experiences. In this correspondence, the current required by the heater may increase with the decrease of the temperature of the power battery.

For example, determining the current required by the heater according to the temperature of the power battery may include: determining the current required by the heater to be a current corresponding to a temperature interval where the temperature of the power battery falls. That is, several current values are set for the current required by the heater, and several temperature intervals are set for the temperature of the power battery, which correspond one-to-one with the several current values set for the current required by the heater. When the temperature of the power battery is in a same temperature interval, the current required by the heater is a current value corresponding to the temperature interval. In this way, the adjustment times of the heater current are reduced, and the failure of the heater caused by frequent adjustment of the current is avoided.

In this example, the maximum output current of the charging device is greater than the maximum permissible charging current of the power battery, but less than the sum of the maximum permissible charging current of the power battery and the current required by the heater, which indicates that the power supplied by the charging device has a margin after meeting the maximum permissible charging current of the power battery, but the margin does not meet the current required by the heater. In this case, the heater may be adjusted to heat the power battery with a current less than that required by the heater, so as to speed up the charging rate of the power battery to a certain extent.

After the heater is activated, the temperature and the state-of-charge of the power battery change in real time, and the current of the heater may be adjusted in real time according to the temperature and the state-of-charge of the power battery. In an example, the adjusting the operating parameter of the heater in step S103 may include: monitoring the temperature and the state-of-charge of the power battery; determining the maximum permissible charging current of the power battery according to the temperature and the state-of-charge of the power battery; and adjusting the current of the heater to make the maximum output current of the charging device greater than or equal to the sum of the maximum permissible charging current of the power battery and the current of the heater.

The temperature of the power battery described herein may be an average value, a maximum value or a minimum value of temperatures of individual battery cells of the power battery detected, which may be monitored by the battery management system. A corresponding between the temperature and state-of-charge of the power battery and the maximum permissible charging current of the power battery may be established in advance based on experiments or experiences, and a corresponding maximum permissible charging current of the power battery may be searched according to the monitored temperature and state-of-charge of the power battery.

If the maximum output current of the charging device is greater than or equal to the sum of the maximum permissible charging current of the power battery and the current of the heater, it may be considered that the adjusted current of the heater does not affect the charging of the power battery with the maximum permissible charging current. In this way, the operation of the heater fully accelerates the charging rate of the power battery.

Usually, when the temperature of the power battery reaches the preset temperature upper limit, the heater may be controlled to stop operation. In yet another example, the heater may also be controlled to stop operation under special situations. The method according to embodiments of the present disclosure may further include: controlling the heater to stop operation, in response to determining that a temperature difference between a battery cell having a maximum temperature and a battery cell having a minimum temperature is greater than a preset temperature value.

When the temperature difference between the battery cell having the maximum temperature and the battery cell having the minimum temperature is greater than the preset temperature value, it may be considered that a temperature difference among the battery cells is too large, which may bring various negative effects. In this case, controlling the heater to stop operation may prevent the temperature difference among the battery cells from further increasing, so as to avoid faults or inaccurate detection caused by the excessive temperature difference.

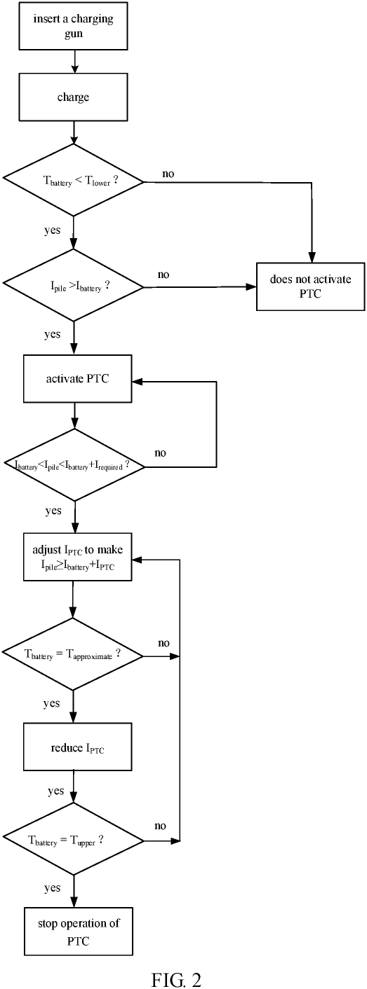

FIG. 2 is a flow chart of a method for controlling charging and heating of a power battery according to another example of the present disclosure. As illustrated in FIG. 2, the power battery starts to be charged when the charging gun is inserted into the charging port of the vehicle, if the temperature of the power battery is less than the preset temperature lower limit (T_{battery} < T_{lower}), and the maximum output current of the charging device is greater than the maximum permissible charging current of the power battery (Iₚᵢₗₑ > I_{battery}), the PTC heater is activated; if the maximum output current of the charging device is greater than the maximum permissible charging current of the power battery, but less than the sum of the maximum permissible charging current of the power battery and the current required by the heater (I_{battery} < Iₚᵢₗₑ < I_{battery} + I_{required}), the current I_{PTC} of the heater is adjusted to make the maximum output current of the charging device is greater than or equal to the sum of the maximum permissible charging current of the power battery and the current of the heater (Iₚᵢₗₑ ≥ I_{battery} + I_{PTC}); if the temperature of the power battery reaches the preset approximate temperature value (T_{battery} = Tₐₚₚᵣₒₓᵢₘₐₜₑ), the heater is controlled to reduce the current I_{PTC}; and if the temperature of the power battery reaches the preset temperature upper limit, the PTC heater is controlled to stop operation.

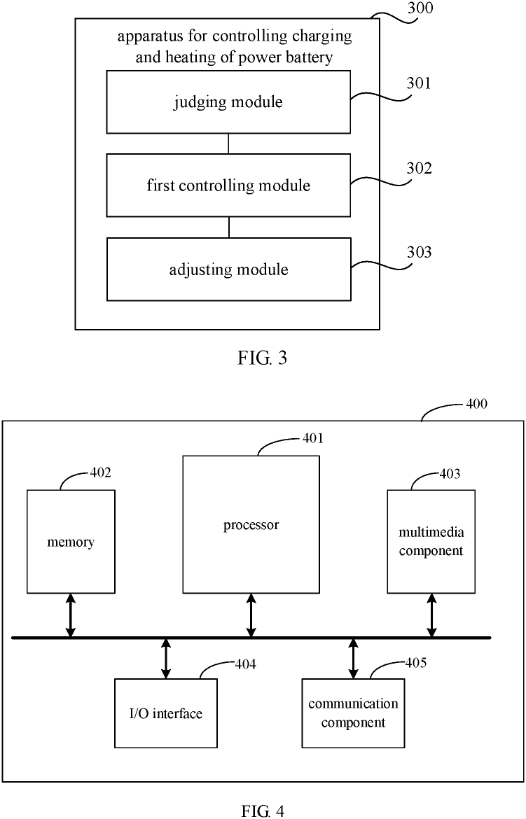

The present disclosure also provides an apparatus for controlling charging and heating of a power battery. FIG. 3 is a block diagram of an apparatus for controlling charging and heating of a power battery according to an example of the present disclosure. As illustrated in FIG. 3, the apparatus 300 for controlling charging and heating of a power battery may include a judging module 301, a first controlling module 302 and an adjusting module 303.

The judging module 301 is configured to determine whether activation of a heater to heat the power battery enables a charging rate of the power battery to be accelerated during charging of the power battery.

The first controlling module 302 is configured to control the heater to be activated to heat the power battery, in response to determining that activation of the heater to heat the power battery enables the charging rate of the power battery to be accelerated.

The adjusting module 303 is configured to adjust an operating parameter of the heater to accelerate the charging rate of the power battery.

In some embodiments, the judging module 301 may include a first judging sub-module.

The first judging sub-module is configured to:
determine that activation of the heater to heat the power battery enables the charging rate of the power battery to be accelerated, in response to determining that a temperature of the power battery is less than a preset temperature lower limit, and a maximum output current of a charging device is greater than a maximum permissible charging current of the power battery, and
determine that activation of the heater to heat the power battery does not enable the charging rate of the power battery to be accelerated, in response to determining that the maximum output current of the charging device is less than or equal to the maximum permissible charging current of the power battery or a temperature of a battery cell of the power battery having a minimum temperature is greater than a preset temperature upper limit.

In some embodiments, the adjusting module 303 may include a first adjusting sub-module, a second adjusting sub-module and a third adjusting sub-module.

The first adjusting sub-module is configured to adjust a current of the heater to be a difference between the maximum output current of the charging device and the maximum permissible charging current of the power battery, in response to determining that the temperature of the power battery is less than a preset approximate temperature value. The preset approximate temperature value is less than the preset temperature lower limit.

The second adjusting sub-module is configured to control the current of the heater to be reduced, in response to determining that the temperature of the power battery reaches the preset approximate temperature value.

The third adjusting sub-module is configured to control the heater to stop operation, in response to determining that the temperature of the power battery reaches a preset temperature upper limit.

In some embodiments, the second adjusting sub-module is configured to control the current of the heater to be reduced with increase in the temperature of the power battery, in response to determining that the temperature of the power battery reaches the preset approximate temperature value.

In some embodiments, the adjusting module 303 may be configured to adjust a current of the heater to make a sum of a maximum permissible charging current of the power battery and the current of the heater equal to or less than a maximum output current of the charging device to accelerate the charging rate of the power battery, in response to determining that the maximum output current of the charging device is greater than the maximum permissible charging current of the power battery, but less than a sum of the maximum permissible charging current of the power battery and a current required by the heater.

In some embodiments, the apparatus 300 may further include a determining module.

The determining module is configured to determine the current required by the heater according to the temperature of the power battery.

In some embodiments, the determining module may include a first determining sub-module.

The first determining sub-module is configured to determine the current required by the heater to be a current corresponding to a temperature interval where the temperature of the power battery falls.

In some embodiments, the adjusting module 303 may include a monitoring module, a second determining sub-module and a fourth adjusting sub-module.

The monitoring module is configured to monitor the temperature and a state-of-charge of the power battery.

The second determining sub-module is configured to determine the maximum permissible charging current of the power battery according to the temperature and the state-of-charge of the power battery.

The fourth adjusting sub-module is configured to adjust a current of the heater to make the maximum output current of the charging device greater than or equal to the sum of the maximum permissible charging current of the power battery and the current of the heater.

In some embodiments, the apparatus 300 may further include a second controlling module.

The second controlling module is configured to control the heater to stop operation, in response to determining that a temperature difference between a battery cell having a maximum temperature and a battery cell having a minimum temperature is greater than a preset temperature value.

Regarding the apparatus as described in the above-mentioned examples, the specific mode in which each module performs the operation has been described in detail in the examples with respect to the method, which will not be elaborated here.

Through the above technical solutions, during charging of the power battery, if it is determined that activation of the heater to heat the power battery is able to speed up the charging rate of the power battery, the heater is controlled to be activated to heat the power batter, and the operating parameter of the heater is adjusted to accelerate the charging rate of the power battery and shorten charging time. The method for controlling charging and heating of a power battery according to the present disclosure avoids the occurrence of a case where the charging rate of the power battery is lowered due to heating the power battery, thereby achieving a balance between the charging time and the energy consumption for heating the power battery.

The present disclosure also provides an electronic device, which includes: a memory and a processor.

The memory has stored therein a computer program. The processor is configured to execute the computer program stored in the memory to realize steps of the method provided above by the present disclosure.

FIG. 4 is a block diagram of an electronic device 400 according to an example of the present disclosure. As illustrated in FIG. 4, the electronic device 400 may include a processer 401 and a memory 402. The electronic device 400 may further include one or more of the following components: a multimedia component 403, an input/output (I/O) interface 404, and a communication component 405.

The processor 401 is configured to control overall operations of the electronic device 800 to perform all or part of the steps in the method for controlling charging and heating of a power battery as described above. The memory 402 is configured to store various types of data to support the operation of the electronic device 400. Such data may include for example instructions for any applications or methods operated on the electronic device 400 and data related to the applications, such as contact data, messages, pictures, audio, video, etc. The memory 402 may be implemented using any type of volatile or non-volatile storage devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk. The multimedia component 403 may includes a screen and a audio component. The screen may be for example a touch screen, and the audio componen is configured to output and/or input audio signals. For example, the audio component may includes a microphone configured to receive an external audio signal. The received audio signal may be further stored in the memory 402 or transmitted via the communication component 405. The audio component further includes at least one speaker to output audio signals. The I/O interface 404 provides an interface between the processor 401 and other interface modules, such as a keyboard, a click wheel, buttons, and the like. The buttons may be virtual buttons or physical buttons. The communication component 405 is configured to facilitate communication, wired or wirelessly, between the electronic device 400 and other devices. The wireless communication may be implemented by such as Wi-Fi, bluetooth, near field communication (NFC), 2G, 3G, 4G, narrow band internet of things (NB-IOT), enhanced machine-type communication (eMTC), 5G, or a combination thereof, which is not specific limited herein. Correspondingly, the communication component 405 may include a Wi-Fi module, a bluetooth module, an NFC module and so on.

In an example, the electronic device 400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the method for controlling charging and heating of a power battery as described above.

In another example, there is also provided a computer-readable storage medium having stored therein a program instruction that, when executed by a processor, causes steps of the method for controlling charging and heating of a power battery as described above to be realized. For example, the computer-readable storage medium may be the above-described memory 402 having stored therein a program instruction, and the program instruction is executable by the processor 401 of the electronic device 400 to realize the method for controlling charging and heating of a power battery as described above.

The present disclosure further provides a vehicle, which includes a power battery and a processor, and the processor is configured to execute steps of the method as described above.

The embodiments of the present disclosure are described in detail above with reference to the accompanying drawings. However, the present disclosure is not limited to the specific details of the above-mentioned embodiments, and various simple modifications can be made to the embodiments of the present disclosure within the technical concept of the present disclosure, which also belong to the protection scope of the present disclosure.

In addition, it should be noted that various specific technical features described in the above-mentioned embodiments can be combined in any suitable manner if not contradictory. In order to avoid unnecessary repetition, various possible combinations will not be elaborated herein.

In addition, various different embodiments of the present disclosure can also be combined arbitrarily, as long as they do not violate the spirit of the present disclosure, and they should also be regarded as the contents disclosed in the present disclosure.

What is claimed is:

1. A method for controlling charging and heating of a power battery, comprising:
determining whether activation of a heater to heat the power battery enables a charging rate of the power battery to be accelerated during charging of the power battery;
controlling the heater to be activated to heat the power battery, in response to determining that activation of the heater to heat the power battery enables the charging rate of the power battery to be accelerated; and
adjusting an operating parameter of the heater to accelerate the charging rate of the power battery.

2. The method according to claim 1, wherein the determining whether activation of the heater to heat the power battery enables the charging rate of the power battery to be accelerated during charging of the power battery comprises:
determining that activation of the heater to heat the power battery enables the charging rate of the power battery to be accelerated, in response to determining that a temperature of the power battery is less than a preset temperature lower limit, and a maximum output current of a charging device is greater than a maximum permissible charging current of the power battery;
determining that activation of the heater to heat the power battery does not enable the charging rate of the power battery to be accelerated, in response to determining that the maximum output current of the charging device is less than or equal to the maximum permissible charging current of the power battery or a temperature of a battery cell of the power battery having a minimum temperature is greater than a preset temperature upper limit.

3. The method according to claim 2, wherein the adjusting the operating parameter of the heater comprises:
adjusting a current of the heater to be a difference between the maximum output current of the charging device and the maximum permissible charging current of the power battery, in response to determining that the temperature of the power battery is less than a preset approximate temperature value;
controlling the current of the heater to be reduced, in response to determining that the temperature of the power battery reaches the preset approximate temperature value; and
controlling the heater to stop operation, in response to determining that the temperature of the power battery reaches a preset temperature upper limit,
wherein the preset approximate temperature value is less than the preset temperature lower limit.

4. The method according to claim 3, wherein the controlling the current of the heater to be reduced in response to determining that the temperature of the power battery reaches the preset approximate temperature value comprises:
controlling the current of the heater to be reduced with increase in the temperature of the power battery, in response to determining that the temperature of the power battery reaches the preset approximate temperature value.

5. The method according to claim 1, wherein the adjusting the operating parameter of the heater to accelerate the charging rate of the power battery comprises:
adjusting a current of the heater to make a sum of a maximum permissible charging current of the power battery and the current of the heater equal to or less than a maximum output current of the charging device to accelerate the charging rate of the power battery, in response to determining that the maximum output current of the charging device is greater than the maximum permissible charging current of the power battery, but less than a sum of the maximum permissible charging current of the power battery and a current required by the heater.

6. The method according to claim 5, further comprising:
determining the current required by the heater according to the temperature of the power battery.

7. The method according to claim 6, wherein the determining the current required by the heater according to the temperature of the power battery comprises:
determining the current required by the heater to be a current corresponding to a temperature interval where the temperature of the power battery falls.

8. The method according to claim 5, wherein the adjusting the current of the heater comprises:
monitoring the temperature and a state-of-charge of the power battery;
determining the maximum permissible charging current of the power battery according to the temperature and the state-of-charge of the power battery; and
adjusting the current of the heater to make the maximum output current of the charging device greater than or equal to the sum of the maximum permissible charging current of the power battery and the current of the heater.

9. The method according to claim 1, further comprising:
controlling the heater to stop operation, in response to determining that a temperature difference between a battery cell having a maximum temperature and a battery cell having a minimum temperature is greater than a preset temperature value.

10. A computer-readable storage medium having stored therein a computer program that, when executed by a processor, causes steps of the method according to claim 1 to be realized.

11. An electronic device, comprising:
a memory, having stored therein a computer program; and
a processor, configured to execute the computer program stored in the memory to realize steps of a method, comprising:
determining whether activation of a heater to heat the power battery enables a charging rate of the power battery to be accelerated during charging of the power battery;
controlling the heater to be activated to heat the power battery, in response to determining that activation of the heater to heat the power battery enables the charging rate of the power battery to be accelerated; and
adjusting an operating parameter of the heater to accelerate the charging rate of the power battery.

12. The electronic device according to claim 11, wherein the determining whether activation of the heater to heat the power battery enables the charging rate of the power battery to be accelerated during charging of the power battery comprises:
determining that activation of the heater to heat the power battery enables the charging rate of the power battery to be accelerated, in response to determining that a temperature of the power battery is less than a preset temperature lower limit, and a maximum output current of a charging device is greater than a maximum permissible charging current of the power battery;
determining that activation of the heater to heat the power battery does not enable the charging rate of the power battery to be accelerated, in response to determining that the maximum output current of the charging device is less than or equal to the maximum permissible charging current of the power battery or a temperature of a battery cell of the power battery having a minimum temperature is greater than a preset temperature upper limit.

13. The electronic device according to claim 12, wherein the adjusting the operating parameter of the heater comprises:
adjusting a current of the heater to be a difference between the maximum output current of the charging device and the maximum permissible charging current of the power battery, in response to determining that the temperature of the power battery is less than a preset approximate temperature value;
controlling the current of the heater to be reduced, in response to determining that the temperature of the power battery reaches the preset approximate temperature value;
controlling the heater to stop operation, in response to determining that the temperature of the power battery reaches a preset temperature upper limit; and
controlling the heater to stop operation, in response to determining that a temperature difference between a battery cell having a maximum temperature and a battery cell having a minimum temperature is greater than a preset temperature value,
wherein the preset approximate temperature value is less than the preset temperature lower limit.

14. The electronic device according to claim 11, wherein the adjusting the operating parameter of the heater to accelerate the charging rate of the power battery comprises:
adjusting a current of the heater to make a sum of a maximum permissible charging current of the power battery and the current of the heater equal to or less than a maximum output current of the charging device to accelerate the charging rate of the power battery, in response to determining that the maximum output current of the charging device is greater than the maximum permissible charging current of the power battery, but less than a sum of the maximum permissible charging current of the power battery and a current required by the heater.

15. The electronic device according to claim 14, wherein the adjusting the current of the heater comprises:
monitoring the temperature and a state-of-charge of the power battery;
determining the maximum permissible charging current of the power battery according to the temperature and the state-of-charge of the power battery; and
adjusting the current of the heater to make the maximum output current of the charging device greater than or equal to the sum of the maximum permissible charging current of the power battery and the current of the heater.

16. A vehicle, comprising:
a power battery; and
a processor, configured to execute steps of a method, comprising:
determining whether activation of a heater to heat the power battery enables a charging rate of the power battery to be accelerated during charging of the power battery;
controlling the heater to be activated to heat the power battery, in response to determining that activation of the heater to heat the power battery enables the charging rate of the power battery to be accelerated; and
adjusting an operating parameter of the heater to accelerate the charging rate of the power battery.

17. The vehicle according to claim 16, wherein the determining whether activation of the heater to heat the power battery enables the charging rate of the power battery to be accelerated during charging of the power battery comprises:
determining that activation of the heater to heat the power battery enables the charging rate of the power battery to be accelerated, in response to determining that a temperature of the power battery is less than a preset temperature lower limit, and a maximum output current of a charging device is greater than a maximum permissible charging current of the power battery;
determining that activation of the heater to heat the power battery does not enable the charging rate of the power battery to be accelerated, in response to determining that the maximum output current of the charging device is less than or equal to the maximum permissible charging current of the power battery or a temperature of a battery cell of the power battery having a minimum temperature is greater than a preset temperature upper limit.

18. The vehicle according to claim 17, wherein the adjusting the operating parameter of the heater comprises:
adjusting a current of the heater to be a difference between the maximum output current of the charging device and the maximum permissible charging current of the power battery, in response to determining that the temperature of the power battery is less than a preset approximate temperature value;
controlling the current of the heater to be reduced, in response to determining that the temperature of the power battery reaches the preset approximate temperature value;
controlling the heater to stop operation, in response to determining that the temperature of the power battery reaches a preset temperature upper limit; and
controlling the heater to stop operation, in response to determining that a temperature difference between a battery cell having a maximum temperature and a battery cell having a minimum temperature is greater than a preset temperature value,
wherein the preset approximate temperature value is less than the preset temperature lower limit.

19. The vehicle according to claim 16, wherein the adjusting the operating parameter of the heater to accelerate the charging rate of the power battery comprises:
adjusting a current of the heater to make a sum of a maximum permissible charging current of the power battery and the current of the heater equal to or less than a maximum output current of the charging device to accelerate the charging rate of the power battery, in response to determining that the maximum output current of the charging device is greater than the maximum permissible charging current of the power battery, but less than a sum of the maximum permissible charging current of the power battery and a current required by the heater.

20. The vehicle according to claim 19, wherein the adjusting the current of the heater comprises:
monitoring the temperature and a state-of-charge of the power battery;
determining the maximum permissible charging current of the power battery according to the temperature and the state-of-charge of the power battery; and
adjusting the current of the heater to make the maximum output current of the charging device greater than or equal to the sum of the maximum permissible charging current of the power battery and the current of the heater.
